(19) United States
(12) Patent Application Publication
(10) Pub. No.: US 2025/0028066 A1
(43) Pub. Date: Jan. 23, 2025

(54) SUBSURFACE PROPERTY ESTIMATION METHOD AND APPARATUS

(71) Applicants: SK INNOVATION CO., LTD., Seoul (KR); SK EARTHON CO., LTD., Seoul (KR)

(72) Inventors: Kyung Min SONG, Daejeon (KR); Seungjun LEE, Daejeon (KR); Seungjoon CHA, Daejeon (KR); Jun Hwan CHOI, Seoul (KR)

(21) Appl. No.: 18/774,435

(22) Filed: Jul. 16, 2024

(30) Foreign Application Priority Data
Jul. 17, 2023 (KR) 10-2023-0092590

(51) Int. Cl. G01V 1/30; G01V 1/28

(52) U.S. Cl. CPC G01V 1/306; G01V 1/282

(57) ABSTRACT

Subsurface property estimation methods are disclosed. In an embodiment, a subsurface property estimation method may include creating, by a computer device, a training data set by preprocessing well-log data and first seismic data, the computer device including at least one processor for executing computer-readable instructions included in a data storage device; creating, by the computer device, an estimation model by using the training data set, the estimation model including: an encoder model configured to create a latent space that reflects features of strata based on input data; a decoder model configured to generate a first factor corresponding to a subsurface property based on the latent space; and a regression model configured to estimate a second factor corresponding to the subsurface property based on the latent space; and estimating the second factor corresponding to the subsurface property by inputting second seismic data to the estimation model.

### CROSS REFERENCE TO RELATED APPLICATION

This patent document claims the priority and benefits of Korean Patent Application No. 10-2023-0092590, filed Jul. 17, 2023, the entire contents of which are incorporated herein by reference for all purposes.

### TECHNICAL FIELD

The disclosed technology relates to a subsurface property estimation method and apparatus.

### BACKGROUND

Oil or natural gas may exist underground in reservoirs of strata such as subsurface rock formations. Exploring for the location at which oil or natural gas lies underground is time-consuming and laborious. One example of oil and gas exploration techniques to obtain well-log data by drilling a well in the ground. However, since this method requires a lot of equipment and costs, as an alternative, a method of obtaining seismic data by performing seismic exploration may be used.

### SUMMARY

The disclosed technology can be implemented in some embodiments to provide a subsurface property estimation method and apparatus using an artificial intelligence model.

In some embodiments of the disclosed technology, a subsurface property estimation method may be performed by a computer device including at least one processor for executing computer-readable instructions included in a storage part. The subsurface property estimation method may include creating, by a computer device, a training data set by preprocessing well-log data and first seismic data, the computer device including at least one processor for executing computer-readable instructions included in a data storage device; creating, by the computer device, an estimation model by using the training data set, the estimation model including: an encoder model configured to create a latent space that reflects features of strata based on input data; a decoder model configured to generate a first factor corresponding to a subsurface property based on the latent space; and a regression model configured to estimate a second factor corresponding to the subsurface property based on the latent space; and estimating the second factor corresponding to the subsurface property by inputting second seismic data to the estimation model.

In an embodiment, the creating of the estimation model may include: creating the encoder model by extracting the features of the strata from the training data set by performing a self-supervised learning on the training data set; creating the decoder model for reconstructing the first factor based on the latent space; creating the regression model for estimating the second factor based on the latent space; and training the encoder model and the decoder model simultaneously by applying weightings of a loss function such that a reconstruction error of the first factor and an estimation error of the second factor are simultaneously minimized.

In an embodiment, the creating of the encoder model may include performing a self-supervised learning algorithm to train an encoder portion of the self-supervised learning algorithm and extract the features of the strata from the training data included in the training data set, and the encoder portion may be extracted to obtain the encoder model.

In an embodiment, the decoder model is created to reconstruct the first factor based on the latent space created by the encoder model, and the decoder model may be trained using the reconstruction error that is obtained by comparing the first factor of first label data included in the training data set with the first factor output by the decoder model when the training data included in the training data set is input to the encoder model.

In an embodiment, the creating of the regression model may include creating a regression equation to estimate the second factor based on the latent space created by the encoder model.

In an embodiment, the training of the encoder model and the decoder model simultaneously may include obtaining the reconstruction error of an output of the first factor by the decoder model and the estimation error of an output of the second factor by the regression model are obtained upon inputting, training the encoder model and the decoder model based on the reconstruction error of the first factor, the encoder model based on the estimation error of the second factor.

In an embodiment, the weightings may be formed such that the loss function for simultaneously training the encoder model and the decoder model reflects the estimation error of the second factor more than the reconstruction error of the first factor.

In an embodiment, the creating of the training data set may include: performing a data preprocessing to: convert the well-log data into time domain data; sample the well-log data to have the same resolution as the seismic data; and apply a smoothing in a horizontal direction of the strata to the first factor to be reconstructed; creating the training data by extracting, for each factor from the seismic data, data in a cube with width, length, and height; creating first label data by extracting, from the seismic data, the first factor of the width, the length, and the height corresponding to the cubes of the training data; and creating second label data by extracting, from the well-log data, the second factor corresponding to the width, the length, or the height of the cubes of the training data.

The disclosed technology can be implemented in some embodiments to provide a subsurface property estimation apparatus including at least one processor, and a storage part connected to the processor such that data transmission and reception are possible, and storing program code written to be executed by the processor to perform the subsurface property estimation method above.

The disclosed technology can be implemented in some embodiments to provide a non-transitory computer-readable recording medium including program code written to be executed by a processor to perform any one of the steps of the subsurface property estimation method above.

The features and advantages of the technology disclosed in this patent document will be more clearly understood through the following detailed description based on the accompanying drawings.

In some embodiments of the disclosed technology, subsurface properties can be estimated with high accuracy by using an artificial intelligence model trained with seismic data and well-log data.

### BRIEF DESCRIPTION OF THE DRAWINGS

FIG. 1 is a flowchart illustrating an example of a subsurface property estimation method based on an embodiment of the disclosed technology.

FIG. 2 is a diagram illustrating an example of a subsurface property estimation apparatus based on an embodiment of the disclosed technology.

FIG. 3 is a diagram illustrating an example of a training data set based on an embodiment of the disclosed technology.

FIG. 4 is a diagram illustrating an example of an estimation model based on an embodiment of the disclosed technology.

FIG. 5 is a diagram illustrating an example of how to train an encoder model based on an embodiment of the disclosed technology.

FIG. 6 is a diagram illustrating an example of how to train a decoder model based on an embodiment of the disclosed technology.

FIG. 7 is a diagram illustrating an example of how to simultaneously train an encoder model and a decoder model based on an embodiment of the disclosed technology.

### DETAILED DESCRIPTION

As discussed above, oil and gas exploration techniques include a method of obtaining well-log data by drilling a well in the ground. Since this method requires a lot of equipment and costs, as an alternative, a seismic exploration technique may be used to obtain seismic data that can be used to estimate subsurface properties, and because it is difficult to perfectly estimate subsurface properties using seismic data alone, well-log data is also analyzed. However, the estimation of the subsurface properties based on the well-log data and seismic data may vary depending on the experience and knowledge of the expert analyzing the well log data and seismic data, and the analysis process is a time-consuming task.

The disclosed technology can be implemented in some embodiments to address these issues by providing an estimation model based on a training data set that is created by preprocessing well-log data and seismic data.

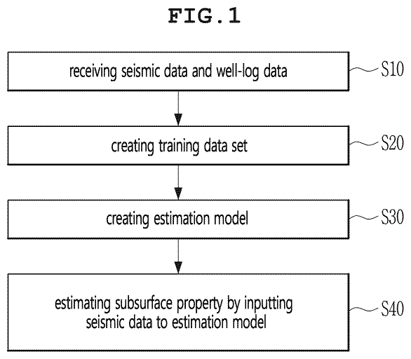

FIG. 1 is a flowchart illustrating an example of a subsurface property estimation method based on an embodiment of the disclosed technology.

The disclosed technology can be implemented in some embodiments to provide a computer device configured to perform a subsurface property estimation method. In some implementations, the computer device may include at least one processor 10 for executing computer-readable instructions included in a storage part 20 (e.g., data storage device). In some implementations, the storage part 20 may include one or more memory devices configured to store data such as the computer-readable instructions. In an embodiment of the disclosed technology, the subsurface property estimation method may include, at S10, receiving well-log data and seismic data; at S20, creating a training data set (TDS) by preprocessing or training the well-log data and the seismic data; at S30, creating an estimation model 100 by using the training data set (TDS); and, at S40, estimating a subsurface property by inputting seismic data to the estimation model 100. In one example, estimating the subsurface property at S40 may include estimating a second factor of the subsurface property. In one example, the estimation model 100 may include: an encoder model 110 for creating a latent space 120 that reflects features of strata based on input data; a decoder model 130 for reconstructing a first factor, which is a subsurface property based on the latent space 120; and a regression model 140 for estimating the second factor of the subsurface property based on the latent space 120; and estimating the second factor that is the subsurface property by inputting seismic data to the estimation model 100 in step S40.

In some implementations, the encoder model 110 may create the latent space 120 by interpreting the input data. In some implementations, the input data may include three-dimensional (3D) data contained in seismic data (such as P-impedance, S-impedance, Vp/Vs, seismic angle, etc.). In some implementations, the decoder model 130 may generate the first factor by reconstructing the input data. In some implementations, the regression model 140 may predict the second factor based on the latent space 120 generated by the encoder model 110. The encoder model 110 and decoder model 130 are trained using the training data set to extract features of strata from the input data, form the latent space 120, and reconstruct the first factor based on the latent space 120. The regression model 140 is trained to estimate the second factor based on the latent space reflecting the input data generated by the encoder model 110.

Well-log data may include values obtained by forming a well in strata and inserting sensors into the well and measuring subsurface properties. The well-log data may further include values that are determined by performing a computation on the measured values. The well-log data may include one or more factors of subsurface properties.

In some embodiments, subsurface properties refer to the properties of strata located below the surface. In some embodiments, factors of the subsurface properties are items that represent the properties of the strata. The factors of the subsurface properties may include information on the properties of the strata. For example, the factors of the subsurface properties may include a measured depth, a well internal caliper, the gamma ray radiation level from underground rock formations, resistivity, bulk density, neutron porosity, a photoelectric factor, the volume of shale, the volume of carbonate, the volume of sand, porosity, water saturation, a bulk modulus, P-wave velocity, S-wave velocity, P-wave impedance, and S-wave impedance. The factors of the subsurface properties may be determined by forming a well in the strata and measuring the factors, or by performing a computation on the measured values of the factors.

Seismic data may be obtained through seismic exploration. In some embodiments, the seismic exploration may include a land exploration that is performed by: generating shock waves on strata, e.g., with explosives; and obtaining data through sensors placed on the ground. The seismic exploration may include determining factors by performing a computation such as an impedance inversion. The seismic data may include factors, such as P-wave impedance, S-wave impedance, and P-wave to S-wave velocity ratio (Vp/Vs).

Among the factors of the various subsurface properties, the first factor may be used as label data for training the encoder model 110 and the decoder model 130 of the estimation model 100. Among the factors of the various subsurface properties, the second factor is a factor that is highly related to the possibility of a reservoir existing underground. In an embodiment, the first factor may be P-wave impedance and the second factor may be porosity. In another embodiment, other factors may be used as the first factor and the second factor.

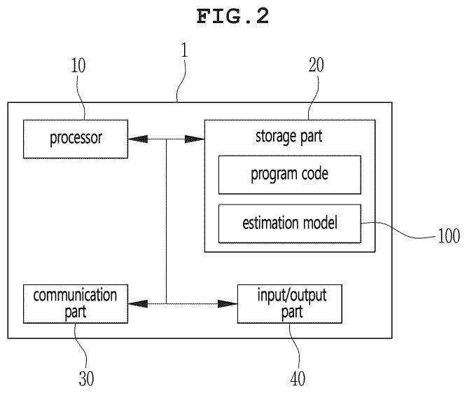

FIG. 2 is a diagram illustrating an example of a subsurface property estimation apparatus 1 based on an embodiment of the disclosed technology. FIGS. 1 and 2 will be referenced together.

The subsurface property estimation apparatus 1 may be realized as a computer device. The subsurface property estimation apparatus 1 may include at least one processor 10 and a storage part 20. The storage part 20 is connected to the processor 10 to enable data transmission and reception, and stores program codes that can be executed by the processor 10 to perform the subsurface property estimation method. The subsurface property estimation apparatus 1 may further include a communication part 30 and an input/output part 40. The communication part 30 is connected to the processor 10 to enable data transmission and reception, and is connected to a wired or wireless network to transmit and receive data. The input/output part 40 allows a user to input data or commands and displays information visually or audibly to the user.

The program codes include a set of instructions that can be executed by the processor 10 to perform the subsurface property estimation method. The processor 10 may read the program codes stored in the storage part 20, and may execute the program codes to perform the subsurface property estimation method. The processor 10 is a computing device that performs an information processing function. Examples of the processor 10 may include a microprocessor 10, a programmable integrated circuit, a central processing unit (CPU), a graphics processing unit (GPU), an application processor (AP), and other semiconductor chips capable of processing information.

Examples of the storage part 20 may include a read-only memory (ROM), a random-access memory (RAM), a flash memory, a hard drive, and a cloud storage in which the program codes are stored. The storage part 20 may store the program codes as well as data for performing the subsurface property estimation method. The storage part 20 may store the well-log data, the seismic data, an index of a cube, a filter, an estimation module, and a self-supervised learning algorithm such as a Bootstrap Your Own Latent (BYOL) structure.

The communication part 30 may communicably connect a subsurface property storage device to external computer devices or sensors to transmit and receive data to and from the external computer devices or the sensors. The communication part 30 may be connected to the wired or wireless network. The communication part 30 may use various communication methods, such as Ethernet, LAN, WAN, IP4, IP6, LTE, 5G, 6G, Zigbee, Wi-Fi, and Bluetooth.

Examples of the input/output part 40 may include input devices, such as a keyboard, a mouse, and a touch pad, and output devices, such as a monitor, a speaker, and a printer. A user may input commands or data through the input/output part 40 to the subsurface property estimation apparatus 1. Through the input/output part 40, the user may recognize a result of estimating the subsurface properties by the subsurface property estimation apparatus 1.

The subsurface property estimation apparatus 1 may be realized as a PC, a server computer, a notebook PC, a tablet PC, or other devices capable of processing information.

In the subsurface property estimation method, the computer device may perform the receiving of the well-log data and the seismic data at S10. The subsurface property estimation apparatus may receive the well-log data and the seismic data through the wired or wireless network, or may read the well-log data and the seismic data from an external storage device (a memory card or a hard drive). The receiving of the well-log data and the seismic data at S10 may include receiving measured data from the sensors inserted into the well and storing the measured data, and receiving measured data from the sensors for seismic exploration and storing the measured data.

In the subsurface property estimation method, when the well-log data and the seismic data are received, the creating of the training data set (TDS) at S20 may be performed. In the creating of the training data set (TDS) at S20, the subsurface property estimation apparatus may preprocess the well-log data and the seismic data and extract part of the data and arrange the extracted data in a determined form to create the training data set (TDS).

The creating of the training data set (TDS) at S20 may include data preprocessing in which the well-log data is converted into time-domain data, the well-log data is sampled to have the same resolution as the seismic data, and smoothing is applied in a horizontal direction of the strata to the first factor to be determined or reconstructed.

The seismic data includes values of factors measured by sensors placed on or in the ground over time, starting from the point in time when the shock is applied to the strata. That is, the seismic data is obtained in a time domain form.

The well-log data includes values of factors measured at the depth to which the sensors are lowered into the well. That is, the well-log data is obtained in a depth domain form. The well-log data may be obtained with higher precision than the seismic data. In some implementations, the term “high precision” may indicate a high resolution to distinguish differences between subsurface properties in 3D space.

In the data preprocessing, the subsurface property estimation apparatus 1 converts the well-log data in the depth domain form into the well-log data in the time domain form. In addition, the well-log data is re-sampled such that the resolution of the well-log data becomes equal to the resolution of the seismic data. In addition, in order to reflect the geological continuity of the strata, a smoothing is performed on the first factor. The smoothing may be performed by applying a filter to data of the first factor. As the filter, a 3D Gaussian filter may be used. The data of the first factor subjected to smoothing may have an improved geological continuity in the horizontal direction. For example, when the smoothing is performed on the data of P-wave impedance, which is the first factor, the P-wave impedance may have an improved continuity in the horizontal direction.

When the data preprocessing is performed, the well-log data and the seismic data have the same state (time domain and resolution). After the data preprocessing is performed, the training data (TD) of the training data set (TDS), and the label data may be created.

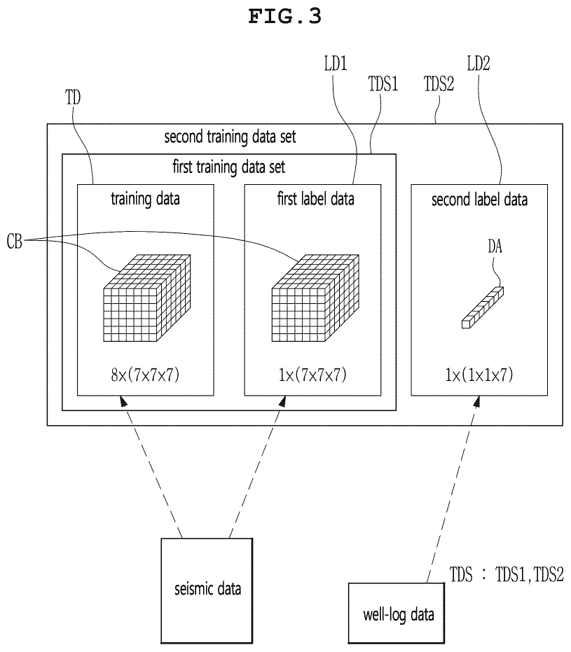

FIG. 3 is a diagram illustrating an example of a training data set (TDS) based on an embodiment of the disclosed technology.

The operation of creating the training data set (TDS) at S20 may include creating the training data (TD) by extracting, for each factor from the seismic data, data in a cube (CB) with width, length, and height. The operation of creating the training data set (TDS) at S20 may include creating first label data (LD1) by extracting, from the seismic data, the first factor of the width, length, and height corresponding to the cubes (CBs) of the training data (TD). The operation of creating the training data set (TDS) at S20 may include creating second label data (LD2) by extracting, from the well-log data, the second factor corresponding to the width, length, or height of the cubes (CBs) of the training data (TD).

The training data set (TDS) may include the training data (TD) and the label data corresponding to the training data (TD). The label data may include the first label data (LD1) and the second label data (LD2).

The training data (TD) may be extracted in the form of a 3D cube (CB) of a predetermined size. The cube (CB) is a 3D matrix structure with predetermined dimensions of width, length, and height. In an embodiment, the cube (CB) is a 3D matrix structure (7×7×7) with seven entries in width, length, and height each, and a value of a factor may be placed in each entry. The training data (TD) and the first label data (LD1) may be extracted in the form of the cube (CB) having the 3D matrix structure.

A certain cube (CB) may include factor values of any part of the strata. The strata from which the well-log data and the seismic data are measured may be divided into a plurality of cubes (CBs). The portion of the well-log data or the seismic data without null data within the cubes (CBs) may be used as the training data (TD). The training data (TD) may be extracted from the well-log data or from the seismic data. To facilitate data handling, the extracted cubes (CBs) may be given serial numbers and indexed.

In the operation of creating the training data (TD), the subsurface property estimation apparatus 1 may create the training data (TD) of a particular strata location by extracting the cubes (CBs) that include the factor values for a predetermined number of factors at the particular strata location. One piece of training data (TD) may include a plurality of cubes (CBs) with different factor values at the same underground location. In an embodiment, the training data (TD) may include a cube (CB) with values of factor S-wave impedance, a cube (CB) with values of factor P-wave impedance, and a cube (CB) with values of factor Vs/Vp. In an embodiment, the training data (TD) may include cubes (CBs) for eight different factors at a particular strata location. The training data (TD) may be expressed in the form of “the number of factors×(the cube (CB) size).” According to an embodiment, the training data (TD) may be expressed as “8×(7×7×7).”

The first label data (LD1) is values of the first factor. In an embodiment, since the first factor is P-wave impedance, the first label data (LD1) is P-wave impedance values included in the seismic data. The first label data (LD1) is a cube (CB)(7×7×7 matrix structure) with P-wave impedance values at the same strata location as the cubes (CBs) of the training data (TD). In an embodiment, the training data set (TDS) may include the training data (TD) having eight cubes (CBs) for different factors, and the first label data (LD1) having one cube (CB) for one first factor. The first label data (LD1) may be expressed in the form of “the number of factors×(the cube (CB) size)”. In an embodiment, the first label data (LD1) may be expressed as “1×(7×7×7)”.

In the creating of the first label data (LD1), the subsurface property estimation apparatus 1 may create the first label data (LD1) by extracting the cube (CB) with the values of the first factor at the same location as the cubes (CBs) of the training data (TD). When the first label data (LD1) is created, the first label data (LD1) corresponding to the training data (TD) extracted from the seismic data may be extracted from the seismic data.

The second label data (LD2) is values of the second factor. In an embodiment, since the second factor is porosity, the second label data (LD2) is porosity values included in the well-log data. The second label data (LD2) is a data array (DA) with porosity values at the same strata location as the cubes (CBs) of the training data (TD). The data array (DA) has a structure in which factor values are arranged in the width, length, or height of the cubes (CBs). For example, the second label data (LD2) is a data array (DA) in which porosity values according to a particular strata location are arranged in the width, length, or height. The second label data (LD2) may be expressed in the form of “the number of factors×(the array length)”. In an embodiment, the second label data (LD2) may be expressed as “1×(1×1×7)”.

Porosity is the factor most relevant to the presence or absence of reservoirs. Porosity is not measured by seismic exploration, so porosity is not present in the seismic data. Porosity is present in the well-log data. Therefore, the second label data (LD2) is extracted from the well-log data.

In an embodiment, the training data set (TDS) may include the training data (TD) with eight cubes (CBs) for different factors, and the second label data (LD2) with a data array (DA) for one second factor.

In the creating of the second label data (LD2), the subsurface property estimation apparatus 1 may create the second label data (LD2) by extracting the cube (CB) with the values of the second factor at the same location as the cubes (CBs) of the training data (TD). When the second label data (LD2) is created, the second label data (LD2) corresponding to the training data (TD) extracted from the well-log data may be extracted from the well-log data.

The training data set (TDS) may include a first training data set (TDS1) including the training data (TD) and the first label data (LD1), and a second training data set (TDS2) including the training data (TD), the first label data (LD1), and the second label data (LD2). As the eight different factors included in the training data (TD), the factors that are present in both the seismic data and the well-log data may be selected. The first label data (LD1) is data for a reconstruction error using the encoder model 110 and the decoder model 130, so the first label data (LD1) may be extracted only from the seismic data. Since the second label data (LD2) is porosity, the second label data (LD2) may be extracted only from the well-log data.

Obtaining the well-log data takes a lot of cost and effort, so the amount of the well-log data is small. Obtaining the seismic data takes relatively less cost and effort than obtaining the well-log data, so the amount of the seismic data is relatively large. For this reason, the number of first training data sets (TDS1s) obtainable from both the well-log data and the seismic data is large, and the number of second training data sets (TDS2s) obtainable only from the well-log data is relatively small. Nevertheless, a subsurface property estimation method according to an embodiment may train the estimation model 100 that estimates porosity, which is the factor present only in the well-log data, with high accuracy.

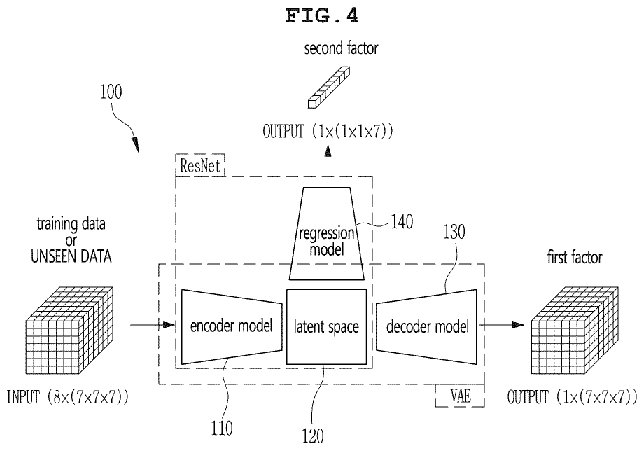

FIG. 4 is a diagram illustrating an example of an estimation model 100 based on an embodiment of the disclosed technology.

Referring to FIGS. 1 and 4, the estimation model 100 may include the encoder model 110, the decoder model 130, and the regression model 140. The encoder model 110 may receive data in the form of a cube and extract features of the strata to create the latent space 120. The latent space 120 is formed by gathering latent features of the strata extracted by the encoder model 110. The decoder model 130 reconstructs the first factor on the basis of the latent space 120. The decoder model 130 may reconstruct the factors of the subsurface properties from the features of the strata that the latent space 120 reflects. The regression model 140 outputs the second factor on the basis of the latent space 120. The regression model 140 estimates the second factor using a regression analysis method from the features of the strata that the latent space 120 reflects.

ResNet structure may be applied to the encoder model 110, the latent space 120, and the regression model 140. The encoder model 110, the latent space 120, and the decoder model 130 may be formed to have a variational auto encoder (VAE) structure.

The creating of the estimation model 100 at S30 may include: extracting the features of the strata from the training data set (TDS) through self-supervised learning by using the training data set (TDS), and creating the encoder model 110 for creating the latent space 120 that reflects the features of the strata; creating the decoder model 130 for reconstructing the first factor on the basis of the latent space 120; creating the regression model 140 for estimating the second factor on the basis of the latent space 120; and training the encoder model 110 and the decoder model 130 simultaneously by applying weightings of a loss function such that a reconstruction error of the first factor and an estimation error of the second factor are simultaneously minimized.

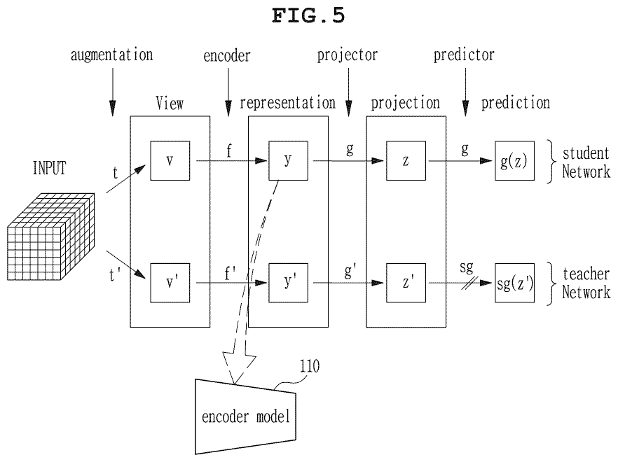

FIG. 5 is a diagram illustrating an example of how to train an encoder model 110 based on an embodiment of the disclosed technology.

The creating of the encoder model 110 may be performed using Bootstrap Your Own Latent (BYOL) among self-supervised learning methods. In the creating of the encoder model 110, Bootstrap Your Own Latent (BYOL), which is self-supervised learning, is used to train an encoder portion of BYOL for extracting the features of the strata from the training data (TD) from the training data set (TDS) and the encoder portion is extracted to obtain the encoder model 110.

In order to create the encoder model 110 through BYOL, a teacher network and a student network are provided. The teacher network and the student network each may include an augmentation part, an encoder, and a projector, and the student network may further include a predictor. The augmentation part receives data in the form of a cube and outputs a view (v, v′) that is a result of augmenting the data. The encoder extracts features of the augmented data and outputs a representation (y, y′). The projector projects the representation and outputs a projection (z, z′). The predictor projects the projection and outputs a prediction (q(z)).

The teacher network is pre-trained using the training data (TD) and then is connected to the student network to start learning. When the training data (TD) is input to the teacher network and a final output (sg(z′)) of the teacher network is generated, the training data (TD) is input to the student network and a final output (q(z)) is generated. The encoder of the student network and a parameter of the projector are trained to minimize a difference between the final output of the student network and the final output of the teacher network. In addition, the encoder of the teacher network and the parameter of the projector may be reset to exponential moving averages of the encoder of the student network and the parameter of the projector. When the student network is trained using a plurality of pieces of training data (TD) and a process of updating the parameter of the teacher network is repeated, the performance of the encoder of the student network in extracting features may be improved.

When the difference between the final output of the student network and the final output of the teacher network is minimized to a determined level, learning is stopped and the encoder of the student network is extracted and placed in the encoder model 110 of the estimation model 100. In the creating of the encoder model 110, only the encoder model 110 may be created with the training data (TD) using BYOL, which is self-supervised learning.

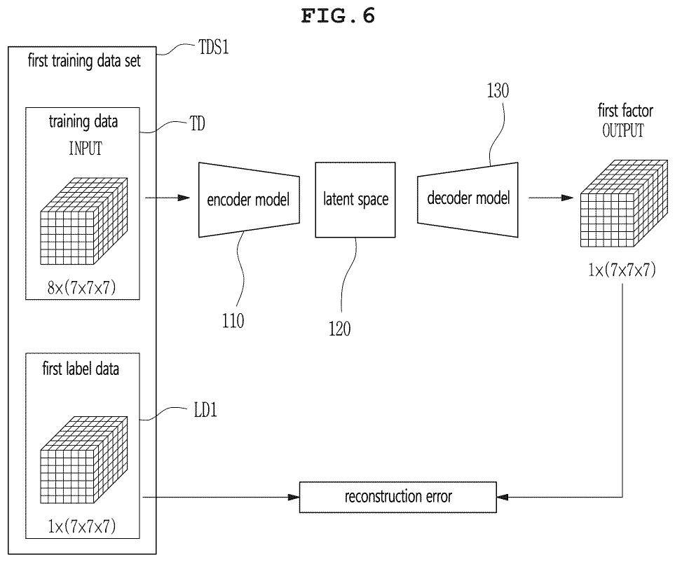

FIG. 6 is a diagram illustrating an example of how to train a decoder model 130 based on an embodiment of the disclosed technology.

In the creating of the decoder model 130, the decoder model 130 is formed to reconstruct the first factor on the basis of the latent space 120 created by the encoder model 110, and the decoder model 130 is trained using the reconstruction error that is obtained by comparing the first factor of the first label data (LD1) included in the training data set (TDS) with the first factor output by the decoder model 130 when the training data (TD) included in the training data set (TDS) is input to the encoder model 110.

The decoder model 130 is a generative model that reconstructs the first factor from the features of the strata included in the latent space 120.

In the creating of the decoder model 130, the decoder model 130 is connected to the encoder created in the creating of the encoder model 110 and the decoder model 130 is trained using a VAE. The encoder model 110 is trained to create the latent space 120 by extracting the features of the strata with the training data (TD). The decoder model 130 is formed to reconstruct the first factor on the basis of the features of the strata included in the latent space 120 generated by the encoder model 110, and is connected to the encoder model 110.

When the training data (TD) is input to the encoder model 110, the encoder model 110 creates the latent space 120 by extracting the feature of the strata of the training data (TD) and the decoder model 130 reconstructs the first factor from the features of the strata included in the latent space 120. The first factor reconstructed by the decoder model 130 and the first factor of the first label data (LD1) are compared to calculate the reconstruction error, and a parameter of the decoder model 130 is trained to minimize the reconstruction error. When the reconstruction error reaches a determined level, learning is stopped and the trained decoder model 130 is obtained.

The decoder model 130 may perform reconstruction on only the first factor, not all factors of the data input to the encoder model 110, and the parameter of the decoder model 130 is trained. The trained decoder model 130 can be set to be in an initial state that is before simultaneous training of both the encoder model 110 and the decoder model 130.

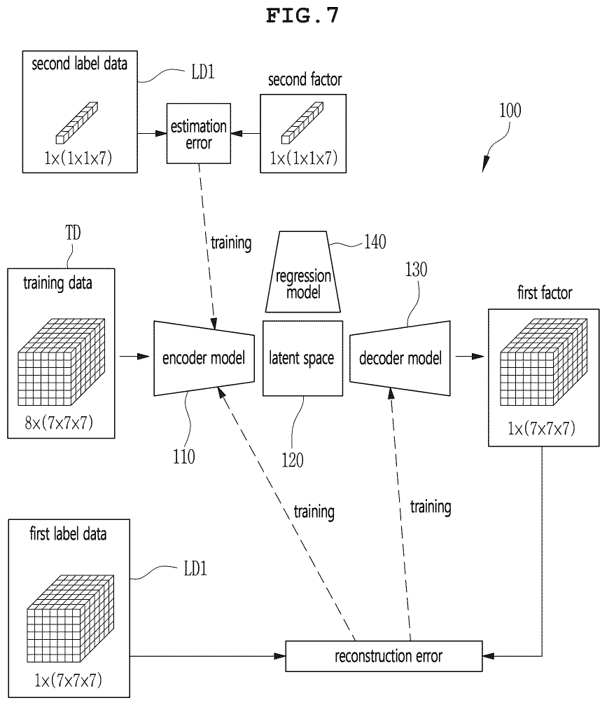

FIG. 7 is a diagram illustrating an example of how to simultaneously train an encoder model 110 and a decoder model 130 based on an embodiment of the disclosed technology.

In the creating of the regression model 140, a regression equation is created to estimate the second factor on the basis of the latent space 120 created by the encoder model 110. The regression model 140 may select a predetermined number of elements from the vectors included in the latent space 120 in descending order of relevance to the second factor and apply the weightings to create the regression equation that best estimates the second factor. When the training data (TD) is input to the encoder model 110, the encoder model 110 creates the latent space 120 and the regression model 140 estimates the second factor according to the regression equation on the basis of the latent space 120. The second factor estimated by the regression model 140 is compared with the second factor of the second label data (LD2) and the regression equation is updated with regression loss to create the regression model 140.

In the estimation model 100, the output of the encoder model 110 is connected to the input of the decoder model 130, and the output of the encoder model 110 is connected to the input of the regression model 140.

In the training of the encoder model 110 and the decoder model 130 simultaneously, when the training data (TD) of the training data set (TDS) is input to the encoder model 110, the reconstruction error of the first factor output by the decoder model 130 and the estimation error of the second factor output by the regression model 140 are obtained, and the encoder model 110 and the decoder model 130 are trained on the basis of the reconstruction error of the first factor, and the encoder model 110 is trained on the basis of the estimation error of the second factor. Herein, the decoder model 130 starts learning from the initial state in which the decoder model 130 is trained in the creating of the decoder model 130.

With the trained encoder model 110, the trained decoder model 130, and the regression model 140 connected, when the training data (TD) is input to the encoder model 110, the decoder model 130 reconstructs and outputs the first factor and the regression model 140 estimates and outputs the second factor. The reconstruction error may be obtained by comparing the first factor output by the decoder model 130 and the first factor of the first label data (LD1). The encoder model 110 and the decoder model 130 may be trained to accurately reconstruct the first factor using the reconstruction error. The estimation error may be obtained by comparing the second factor output by the regression model 140 and the second factor of the second label data (LD2). The encoder model 110 may be trained to accurately estimate the second factor using the estimation error. Training the encoder model 110 and the decoder model 130 using the reconstruction error and training the encoder model 110 using the estimation error may be performed simultaneously. To this end, herein, the two errors (the reconstruction error ad the estimation error) may be combined into one loss function to perform training for minimizing the two errors simultaneously.

In some implementations, since the first factor in in the form of a cube (7×7×7) and the second factor is in the form of a data array (1×1×7), the amount of data related to the first factor is larger. Therefore, when the reconstruction error and the estimation error are reflected to the loss function at the same ratio, the encoder model 110 and the decoder model 130 are likely to be trained in such a manner that the reconstruction error is minimized more than the estimation error. However, a subsurface property estimation method according to an embodiment is intended to explore strata in which reservoirs may be present, so the performance of accurately estimating the second factor related to the presence of reservoirs is important. Therefore, the weightings may be formed such that the loss function for simultaneously training the encoder model 110 and the decoder model 130 reflects the estimation error of the second factor more than the reconstruction error of the first factor. The loss function may include a reconstruction error portion and an estimation error portion. It may be determined that the weighting multiplied by the reconstruction error portion may be less than the weighting multiplied by the estimation error portion. By training the encoder model 110 using the loss function with the adjusted weightings, the performance of the encoder model 110 in extracting the features of the strata may be improved in such a manner that the performance of reconstructing the first factor and the performance of estimating the second factor are simultaneously improved.

By performing this process, the estimation model 100 including the encoder model 110, the decoder model 130, and the regression model 140 may be created.

Referring to FIG. 1, in the estimating of the second factor at S40, unseen data is input to the estimation model 100 trained using the training data set (TDS), and the estimation model 100 estimates and outputs the second factor corresponding to the input unseen data. Regarding the unseen data, the term unseen means data that is not used for learning in the process of creating the estimation model 100. That is, the unseen data refers to data that the estimation model 100 did not see during learning.

The unseen data may be in the same form as the training data (TD). For example, the unseen data may be in the form of a 3D cube with eight factors, and may be formed to have a structure expressed as 8×(7×7×7). The unseen data may be obtained from seismic data resulting from seismic exploration of strata to determine whether reservoirs are present.

Drilling a well in strata is expensive, whereas seismic exploration can be done at a relatively low cost. Seismic exploration is performed on a region for which whether reservoirs are present is wanted to be determined, and unseen data is obtained from seismic data resulting from seismic exploration. When the unseen data is input to the estimation model 100, the estimation model 100 may estimate and output the second factor that is most relevant to whether the reservoirs are present at the location of the strata. Accordingly, by using a subsurface property estimation method according to an embodiment, data for determining whether reservoirs are present may be obtained using a result of seismic exploration, which is relatively inexpensive.

A non-transitory computer-readable recording medium may include program codes that can be executed by the processor 10 to perform any one of the steps of a subsurface property estimation method according to an embodiment. Examples of the non-transitory computer-readable recording medium may include: electrically recorded media, such as memory cards and USB memories; magnetically recorded media, such as hard drives and magnetic tapes; optically recorded media, such as CDs, DVDs, and Blu-ray discs; and cloud storages.

Only a few implementations and examples are described and other implementations, enhancements and variations can be made based on what is described and illustrated in this patent document.

What is claimed is:

1. A subsurface property estimation method comprising:
creating, by a computer device, a training data set by preprocessing well-log data and first seismic data, the computer device including at least one processor for executing computer-readable instructions included in a data storage device;
creating, by the computer device, an estimation model by using the training data set, the estimation model including: an encoder model configured to create a latent space that reflects features of strata based on input data; a decoder model configured to generate a first factor corresponding to a subsurface property based on the latent space; and a regression model configured to estimate a second factor corresponding to the subsurface property based on the latent space; and
estimating the second factor corresponding to the subsurface property by inputting second seismic data to the estimation model.

2. The subsurface property estimation method of claim 1, wherein the creating of the estimation model comprises:
creating the encoder model by extracting the features of the strata from the training data set by performing a self-supervised learning on the training data set;
creating the decoder model for reconstructing the first factor based on the latent space;
creating the regression model for estimating the second factor based on the latent space; and
training the encoder model and the decoder model simultaneously by applying weightings of a loss function such that a reconstruction error of the first factor and an estimation error of the second factor are simultaneously minimized.

3. The subsurface property estimation method of claim 2, wherein the creating of the encoder model includes performing a self-supervised learning algorithm to train an encoder portion of the self-supervised learning algorithm and extract the features of the strata from the training data included in the training data set, and the encoder portion is extracted to obtain the encoder model.

4. The subsurface property estimation method of claim 2, wherein the decoder model is created to reconstruct the first factor based on the latent space created by the encoder model, and the decoder model is trained using the reconstruction error that is obtained by comparing the first factor of first label data included in the training data set with the first factor output by the decoder model when the training data included in the training data set is input to the encoder model.

5. The subsurface property estimation method of claim 2, wherein the creating of the regression model includes creating a regression equation to estimate the second factor based on the latent space created by the encoder model.

6. The subsurface property estimation method of claim 2, wherein the training of the encoder model and the decoder model simultaneously includes:
obtaining the reconstruction error of an output of the first factor by the decoder model and the estimation error of an output of the second factor by the regression model are obtained upon inputting the training data of the training data set to the encoder model;
training the encoder model and the decoder model based on the reconstruction error of the first factor, the encoder model based on the estimation error of the second factor; and
forming the weightings such that the loss function for simultaneously training the encoder model and the decoder model reflects the estimation error of the second factor more than the reconstruction error of the first factor.

7. The subsurface property estimation method of claim 1, wherein the creating of the training data set comprises:
performing a data preprocessing to: convert the well-log data into time-domain data; sample the well-log data to have a same resolution as the seismic data; and apply a smoothing in a horizontal direction of the strata to the first factor to be reconstructed;
creating the training data by extracting, for each factor from the seismic data, data in a cube with width, length, and height;
creating first label data by extracting, from the seismic data, the first factor of the width, the length, and the height corresponding to the cubes of the training data; and
creating second label data by extracting, from the well-log data, the second factor corresponding to the width, the length, or the height of the cubes of the training data.

8. A subsurface property estimation apparatus, comprising:
at least one processor; and
a storage part in communication with the at least one processor to transmit or receive data to or from the at least one processor and configured to store program codes to be executed by the at least one processor to perform a subsurface property estimation method,
wherein the subsurface property estimation method comprises:
creating a training data set by preprocessing well-log data and first seismic data;
creating an estimation model by using the training data set, the estimation model including: an encoder model configured to create a latent space that reflects features of strata based on input data; a decoder model configured to generate a first factor corresponding to a subsurface property based on the latent space; and a regression model configured to estimate a second factor corresponding to the subsurface property based on the latent space; and
estimating the second factor corresponding to the subsurface property by inputting second seismic data to the estimation model.

9. The subsurface property estimation apparatus of claim 8, wherein the creating of the estimation model comprises:
creating the encoder model by extracting the features of the strata from the training data set by performing a self-supervised learning on the training data set;
creating the decoder model for reconstructing the first factor based on the latent space;
creating the regression model for estimating the second factor based on the latent space; and
training the encoder model and the decoder model simultaneously by applying weightings of a loss function such that a reconstruction error of the first factor and an estimation error of the second factor are simultaneously minimized.

10. The subsurface property estimation apparatus of claim 9, wherein the creating of the encoder model includes performing a self-supervised learning algorithm to train an encoder portion of the self-supervised learning algorithm and extract the features of the strata from the training data included in the training data set, and the encoder portion is extracted to obtain the encoder model.

11. The subsurface property estimation apparatus of claim 9, wherein the decoder model is created to reconstruct the first factor based on the latent space created by the encoder model, and the decoder model is trained using the reconstruction error that is obtained by comparing the first factor of first label data included in the training data set with the first factor output by the decoder model when the training data included in the training data set is input to the encoder model.

12. The subsurface property estimation apparatus of claim 9, wherein the creating of the regression model includes creating a regression equation to estimate the second factor based on the latent space created by the encoder model.

13. The subsurface property estimation apparatus of claim 9, wherein the training of the encoder model and the decoder model simultaneously includes:
obtaining the reconstruction error of an output of the first factor by the decoder model and the estimation error of an output of the second factor by the regression model are obtained upon inputting the training data of the training data set is input to the encoder model;
training the encoder model and the decoder model based on the reconstruction error of the first factor, the encoder model based on the estimation error of the second factor; and
forming the weightings such that the loss function for simultaneously training the encoder model and the decoder model reflects the estimation error of the second factor more than the reconstruction error of the first factor.

14. The subsurface property estimation apparatus of claim 9, wherein the creating of the training data set comprises:
performing a data preprocessing to: convert the well-log data into time domain; sample the well-log data to have a same resolution as the seismic data; and apply a smoothing in a horizontal direction of the strata to the first factor to be reconstructed;
creating the training data by extracting, for each factor from the seismic data, data in a cube with width, length, and height;
creating first label data by extracting, from the seismic data, the first factor of the width, the length, and the height corresponding to the cubes of the training data; and
creating second label data by extracting, from the well-log data, the second factor corresponding to the width, the length, or the height of the cubes of the training data.

15. A non-transitory computer-readable recording medium, comprising program code written to be executed by a processor to perform a subsurface property estimation method, the method comprising:
creating, by a computer device, a training data set by preprocessing well-log data and first seismic data, the computer device including at least one processor for executing computer-readable instructions included in a data storage device;
creating, by the computer device, an estimation model by using the training data set, the estimation model including: an encoder model configured to create a latent space that reflects features of strata based on input data; a decoder model configured to generate a first factor corresponding to a subsurface property based on the latent space; and a regression model configured to estimate a second factor corresponding to the subsurface property based on the latent space; and
estimating the second factor corresponding to the subsurface property by inputting second seismic data to the estimation model.

16. The non-transitory computer-readable recording medium of claim 15, wherein the creating of the estimation model comprises:
creating the encoder model by extracting the features of the strata from the training data set by performing a self-supervised learning on the training data set;
creating the decoder model for reconstructing the first factor based on the latent space;
creating the regression model for estimating the second factor based on the latent space; and
training the encoder model and the decoder model simultaneously by applying weightings of a loss function such that a reconstruction error of the first factor and an estimation error of the second factor are simultaneously minimized.

17. The non-transitory computer-readable recording medium of claim 16, wherein the creating of the encoder model includes performing a self-supervised learning algorithm to train an encoder portion of the self-supervised learning algorithm and extract the features of the strata from the training data included in the training data set, and the encoder portion is extracted to obtain the encoder model, and
wherein the decoder model is created to reconstruct the first factor based on the latent space created by the encoder model, and the decoder model is trained using the reconstruction error that is obtained by comparing the first factor of first label data included in the training data set with the first factor output by the decoder model when the training data included in the training data set is input to the encoder model.

18. The non-transitory computer-readable recording medium of claim 16, wherein the creating of the regression model includes creating a regression equation to estimate the second factor based on the latent space created by the encoder model.

19. The non-transitory computer-readable recording medium of claim 16, wherein the training of the encoder model and the decoder model simultaneously includes:
obtaining the reconstruction error of an output of the first factor by the decoder model and the estimation error of an output of the second factor by the regression model are obtained upon inputting the training data of the training data set to the encoder model;
training the encoder model and the decoder model based on the reconstruction error of the first factor, the encoder model based on the estimation error of the second factor; and
forming the weightings such that the loss function for simultaneously training the encoder model and the decoder model reflects the estimation error of the second factor more than the reconstruction error of the first factor.

20. The non-transitory computer-readable recording medium of claim 15, wherein the creating of the training data set comprises:
performing a data preprocessing to: convert the well-log data into time-domain data; sample the well-log data to have a same resolution as the seismic data; and apply a smoothing in a horizontal direction of the strata to the first factor to be reconstructed;
creating the training data by extracting, for each factor from the seismic data, data in a cube with width, length, and height;
creating first label data by extracting, from the seismic data, the first factor of the width, the length, and the height corresponding to the cubes of the training data; and
creating second label data by extracting, from the well-log data, the second factor corresponding to the width, the length, or the height of the cubes of the training data.
